(19) United States
(12) Patent Application Publication
(10) Pub. No.: US 2007/0085789 A1
(43) Pub. Date: Apr. 19, 2007

(54) Multiple primary color display system and method of display using multiple primary colors

(75) Inventor: Adrianus J.S. De Vaan, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/571,714

(22) PCT Filed: Sep. 27, 2004
(86) PCT No.: PCT/IB04/51871

§ 371 Date: Mar. 10, 2006

Related U.S. Application Data
(60) Provisional application No. 60/507,140, filed on Sep. 30, 2003.

(51) Int. Cl. G09G 3/36

(52) U.S. Cl. 345/88

(57) ABSTRACT

A color display system and a method of displaying an image uses at least four primary colors, where one of the primary colors can achieve substantially greater brightness levels than the closest of the three other primary colors. Where six primary colors are used, color saturation requirements and brightness requirements for the display system can be effectively separated between different primary color elements. Therefore, there is no longer such a severe requirement to use only materials that can simultaneously provide high color saturation and brightness. Accordingly, a color display system, with two sets of three primary colors can utilize a wider range of materials, and simultaneously achieve higher color saturation and brightness levels.

This invention pertains to the field of color displays and more particularly, to a color display system and a method of color display using multiple primary colors.

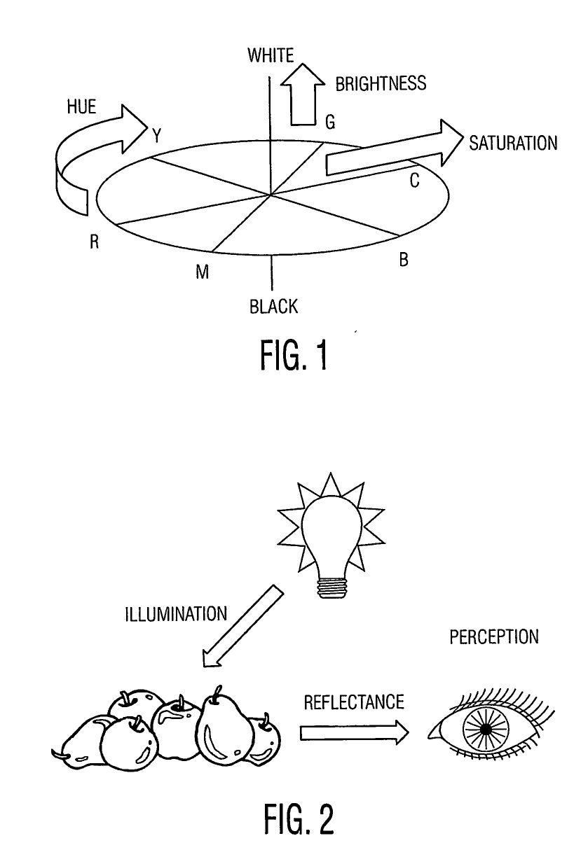

Color can be defined in terms of three essential parameters: hue, saturation, and brightness. These three parameters will now be explained in further detail with respect to the well-known Newton color circle, which is shown in FIG. 1.

Hue is related to a wavelength for spectral colors. The terms “red” and “blue” are primarily describing hue. It is convenient to arrange the saturated hues around the circumference of Newton color circle as shown in FIG. 1. Starting from red and proceeding clockwise around the circle to blue proceeds from long to shorter wavelengths. However FIG. 1 shows that not all hues can be represented by spectral colors since there is no single wavelength of light which has the magenta hue—it may be produced by an equal mixture of red and blue. There are many different mixtures of wavelengths that can produce the same perceived hue. The achromatic line from black to gray to white through the center of the circle represents light that has no hue.

Saturation relates to the purity of the color. In FIG. 1, the saturation of a color is represented as the radial distance that the color is located from the central axis to the circumference of the color circle. A fully saturated color is one with no mixture of white, and is located on the circumference of the Newton color circle. Pink may be thought of as having the same hue as red but being less saturated. Thus, with respect to FIG. 1, pink may be located along a same radial line as red, but it would be located closer to the central axis. A spectral color consisting of only one wavelength is fully saturated, but one can have a fully saturated magenta, which is not a spectral color. Quantifying the perception of saturation by a human eye, as discussed in more detail below, must take into account the fact that some spectral colors are perceived to be more saturated than others. For example, monochromatic reds and violets are perceived to be more saturated than monochromatic yellows. There are also more perceptibly different levels of saturation for some hues.

Brightness has been defined as exhibiting more or less light. In FIG. 1, the brightness of a color is represented in terms of its location with respect to the vertical axis. The brightness of a colored surface depends upon the illuminance and upon its reflectivity. Equal surfaces with differing spectral characteristics but which emit the same number of lumens will be perceived to be equally bright. If one surface emits more lumens, it will be perceived to be brighter in a logarithmic relationship, which yields a constant increase in brightness of about 1.5 units with each doubling of brightness. That is, as perceived by the human eye, brightness is not linearly proportional to the reflectivity. Accordingly, a scale from 0 to 10 is used to represent perceived brightness in some color measurement systems.

So, it can be seen that two different colors may have an identical hue, but different saturation and/or brightness values.

In view of the foregoing, it will be understood that as the term is used herein, a color is a unique combination of hue, saturation, and brightness values. Further understanding if these terms may be had by reference to “CIE Colorimetry,” Publication 15.2 of the Commission Internationale d'Eclairage (International Commission on Illumination) (CIE) (1986). Another good reference for explaining these terms is “Measuring Colour,” R. W. G. Hunt, 2nd Edition (1991).

FIG. 2 explains the fundamental process in nature by which a human eye sees colors. An object is illuminated with light from a light source, and the spectral light distribution that is reflected by the object determines the object's color as perceived by the eye.

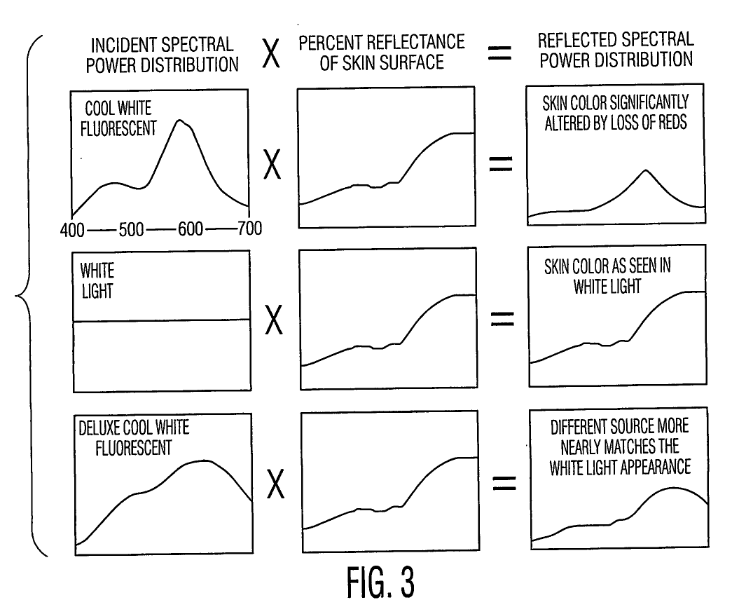

FIG. 3 illustrates how the color spectrum of an object is a function of both its reflectance spectral power distribution and the spectrum of the light source that illuminates the object.

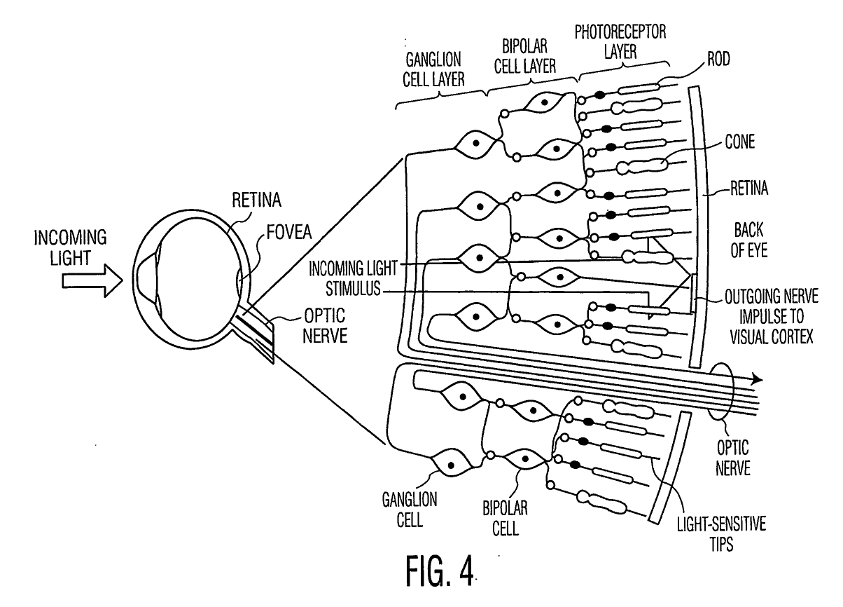

FIG. 4 shows elements of a human eye 100. The retina 105 of the eye includes a plurality of photosensitive cells called rods 1 10 and cones 120 that convert incident light energy into signals that are carried to the brain by the optic nerve 150. In the middle of the retina 105 is a small dimple called the fovea or fovea centralis 160. The fovea 160 is the center of the eye's sharpest vision and the location of most color perception. The eye includes roughly 120 million rods 110, each about 0.002 mm in diameter, and 6 or 7 million cones 120, each about 0.006 mm in diameter.

This ensemble of rods 110 in some respects has the characteristics of a high-speed, black and white film (such as Tri-X). The rods 110 are exceedingly sensitive, performing in light too dim for the cones 120 to respond to, yet they are unable to distinguish color. Also, the images relayed to the brain by the rods 110 are not well defined. That is, the rods 110 are more sensitive to detect light at lower intensity levels than the cones 120, but do not distinguish between colors. The rods 120 are the primary source of vision at night.

In contrast, the ensemble of cones can be imagined as a separate, but overlapping, low-speed color film. They perform well in bright light, giving detailed colored views, but they are fairly insensitive at low light levels. That is, the cones 120 have a higher light threshold for activation than the rods 110 (they are less sensitive to overall light intensity).

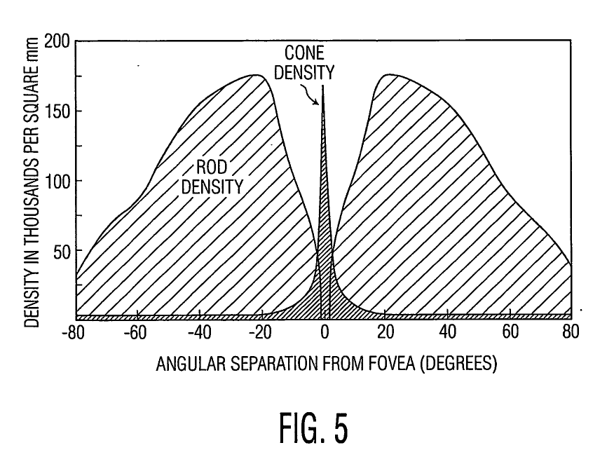

FIG. 5 shows the density curves for the rods 110 and cones 120 in the retina 105 as a function of angular separation from the fovea 160.

There are three different types of cones 120, each one of which process different colors of the spectrum differently. The three types of cones 120 are generally referred to as cyanolabes, chlorolabes, and erytholabes. Cyanolabes are most sensitive to blue light, chlorolabes are most sensitive to green light, and erytholabes are most sensitive to red light. The chlorolabes and erytholabes are mostly packed into the fovea centralis region of the eye. The cyanolabes are mostly found outside the fovea. It is currently believed, based on measured response curves, that the 6 to 7 million cones 120 are divided as follows: 64% erytholabes, 32% chlorolabes, and 2% cyanolabes.

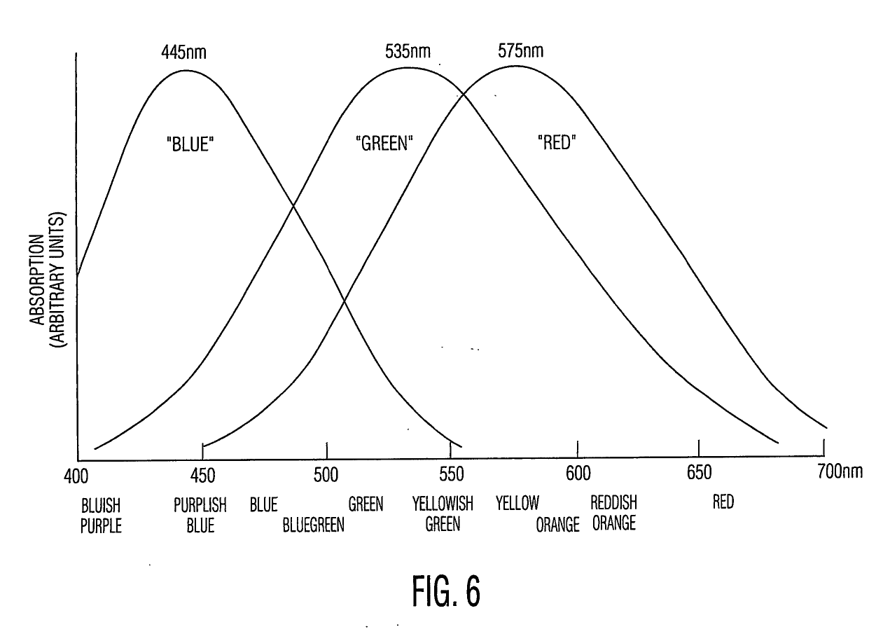

FIG. 6 shows the sensitivity profiles of the three types of cones 120 (cyanolabes, chlorolabes, and erytholabes) as a function of wavelength. As shown in FIG. 6: the peak sensitivity for a cyanolabe is around 440-445 nm, the peak sensitivity for a chlorolabe is around 535-545 nm, and the peak sensitivity for a erytholabe is around 575-580 nm. In actuality, the peak sensitivities of both the chlorolabe and the erytholabe are in the yellowish part of the color spectrum (yellowish-green and yellowish-orange, respectively).

Color matching studies carried out in the 1920s showed that colored samples could be matched by combinations of monochromatic primary colors Red (700 nm), Green (546.1 nm) and Blue (435.8 nm). The average responses of a large group of observers can be reproduced by a set of three color matching functions. One set of commonly used color matching functions are CIE color matching functions. FIG. 7 shows the CIE color matching functions.

Any set of three colors which, when added in appropriate combination can yield white, are called “primary colors.” It is useful to map a color space with a set of primary colors, such as blue, green, and red. If unit amounts of B, G, and R colors produce white light, then theses three colors can be used like unit vectors to define the color space.

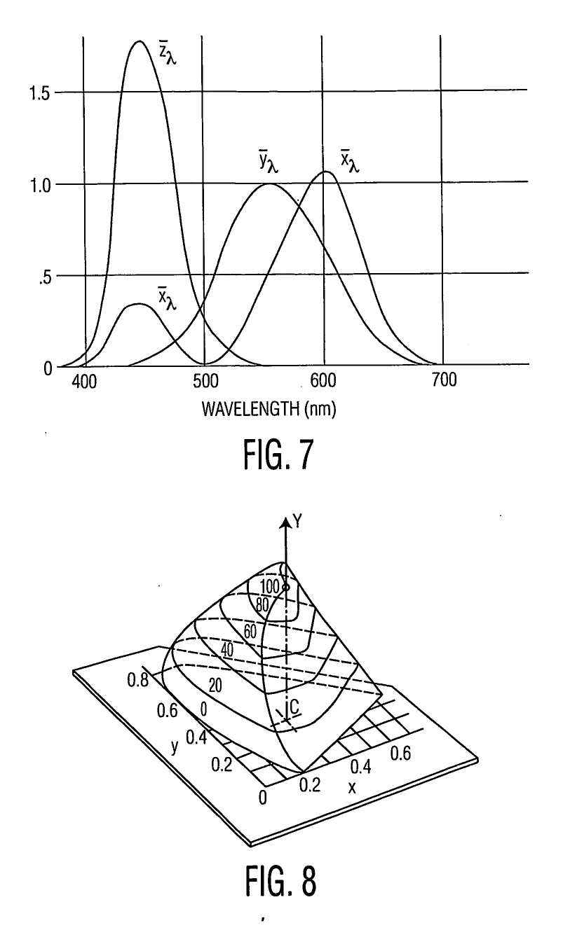

The CIE color space uses a parameter Y to measure brightness, and parameters x and y to specify the chromaticity which covers the properties hue and saturation on a two dimensional chromaticity diagram. FIG. 8 shows the CIE color space.

Based on the fact that the human eye has three different types of color sensitive cones, as discussed above, the response of the eye is best described in terms of three “tristimulus values,” usually denoted as X, Y and Z. From the color matching functions, one can derive tristimulus values that specify the chromaticity. However, once this is accomplished, it is found that the colors can be expressed in terms of the two color coordinates x and y.

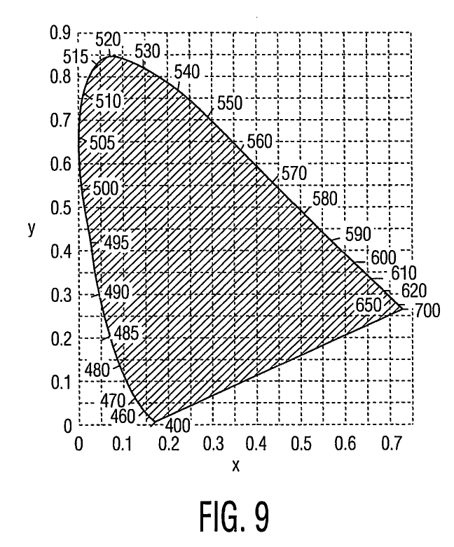

FIG. 9 shows the 1931 CIE standard chromaticity diagram. This diagram represents the mapping of human color perception in terms of two CIE parameters x and y. The diagram includes all of the colors perceivable by the normal human eye. The spectral colors are distributed around the edge of the “color space” as shown, and that outline includes all of the perceived hues and provides a framework for investigating color.

In general existing color display systems display images using a set of only three primary colors, typically red, green, and blue. An existing display system combines the three primary colors with appropriate weightings to produce all of the various colors to be displayed.

However, one cannot display the entire range of human color perception by combinations of only three primary colors (e.g., RGB). The colors which can be matched by combining a given set of three primary colors (such as the blue, green, and red of a color television screen) are represented on the chromaticity diagram by a triangle joining the coordinates for the three colors, the interior of which is referred to as its gamut.

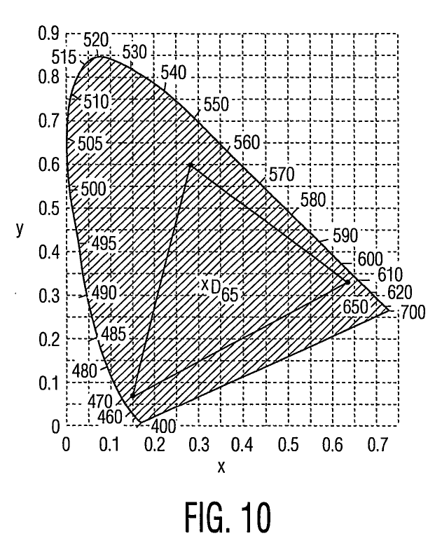

FIG. 10 shows the European Broadcast Union (EBU) RGB color gamut plotted on the CIE chromaticity diagram. As can be seen from FIG. 10, the gamut of normal human vision covers the entire CIE diagram, while the gamut of the EBU RGB color standard forms a more limited triangular region within the CIE diagram. In the EBU standard, the three corners of the triangle are defined by red (R), blue (B), and green (G) color points as follows: R={x=0.640, y=0.330}; G={x=0.290, y=0.600}; and B={x=0.150, y=0.060}.

FIG. 10 also shows the standard D₆₅ white color point, which is obtained by mixing the EBU R, G, and B colors in proper proportions.

It is important for many displays to be able to fully reproduce the entire EBU color gamut, as this is a widely-adopted standard for video displays. However, it is also desired to provide a display which can not only reproduce all colors within the EBU color gamut, but which can do so with high brightness levels.

From the discussion above, it can be seen that the three primary color elements in existing displays simultaneously need to be able to cover a large color gamut and to generate the high brightness levels that are required at certain color points in the color space.

These fundamental requirements limit the choice of materials and components which are available to produce a display device. For example, with phosphor-based display systems, phosphors must be selected that can provided saturated colors and also can handle the high loads to generate a desired brightness level. Due to the high load and desire for a long-lived phosphor, the choice of phosphor materials is rather limited. Similarly, with laser projection displays the existing three-primary-color systems require high-powered lasers having good color points and long lifetimes. Such lasers are not available at this time.

In an attempt to address some of these requirements, some digital light processing (DLP) projectors add a fourth white color element to the three standard primary color elements for red, green and blue. The white color element has a color point at or very close to the desired white color point for the system (e.g., D65, 9200K, etc.). However, such an approach does not expand the color gamut, or permit increased intensity for highly saturated colors that are located far away from the white color point.

Accordingly, it would be desirable to provide to a color display system and a method of color display that can simultaneously meet color saturation and brightness requirements. It would also be desirable to provide such a color display system that can utilize a wider range of materials, including longer-lived materials. The present invention is directed to addressing one or more of the preceding concerns.

In one aspect of the invention, a color display system comprises a plurality of pixels, and means for controlling the plurality of pixels to display an image. Each pixel comprises a first set of three primary color elements and a second set of three primary color elements. Each of the primary color elements of the first set has a different color than any of the other primary color elements of the first set, and each of the primary color elements of the second set has a different color than any of the other primary color elements of the second set and the first set.

In another aspect of the invention, a color display system comprises first, second, third, and fourth primary color elements. Each first through fourth primary color elements has a different color. The first through third primary color elements together span a first color gamut. The fourth primary color element is capable of producing a substantially greater brightness level than the one of the first through third primary color elements whose color is closest to the color of the fourth primary color element.

In yet another aspect of the invention, a method of displaying a pixel of an image, comprises: providing first, second, and third primary color elements, the first through third primary color elements having three corresponding colors that are different from each other, and said first through third primary color elements together spanning a first color gamut; providing a fourth primary color element having a different color than any of the first through third primary color elements, wherein the fourth primary color element is capable of producing a substantially greater brightness level than a one of the first through third primary color elements having a color closest to the color of the fourth primary color element; and proportionately combining the colors produced the first through fourth color elements to produce a desired pixel color.

Further and other aspects will become evident from the description to follow.

FIG. 1 shows a Newton color circle;

FIG. 2 shows the fundamental process in nature by which a human eye sees colors;

FIG. 3 illustrates how the color spectrum of an object is a function of both its reflectance spectral power distribution and the spectrum of the light source that illuminates the object;

FIG. 4 shows elements of a human eye 100;

FIG. 5 shows the density curves for rods and cones in the retina as a function of angular separation from the fovea;

FIG. 6 shows the sensitivity profiles of the cyanolabes, chlorolabes, and erytholabes as a function of wavelength;

FIG. 7 shows the CIE color matching functions;

FIG. 8 shows the CIE color space;

FIG. 9 shows the 1931 CIE standard chromaticity diagram;

FIG. 10 shows the gamut of colors that can be reproduced with a color display system using one set of three primary colors;

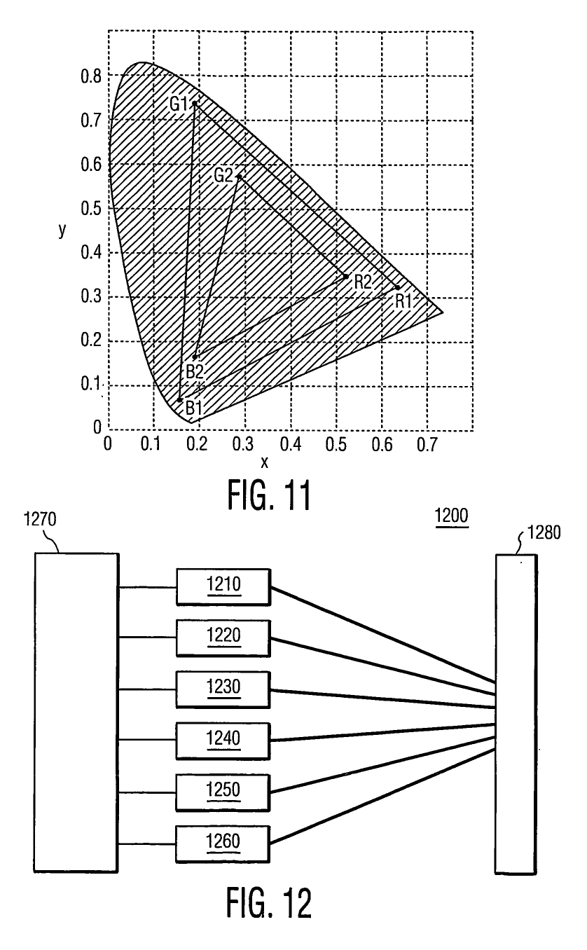

FIG. 11 shows the gamut of colors that can be reproduced with a color display system using two different sets of three primary colors;

FIG. 12 illustrates a first embodiment of a color display device using six primary colors;

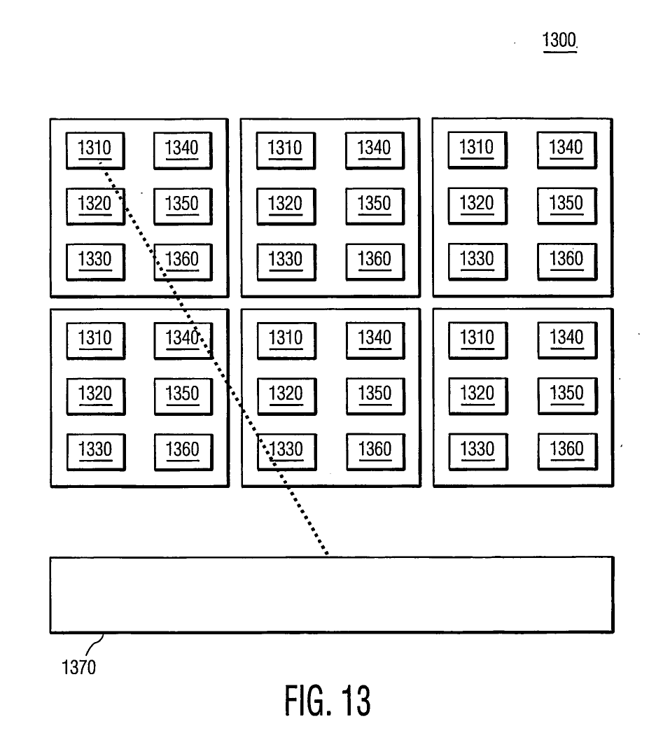

FIG. 13 illustrates a second embodiment of a color display device using six primary colors;

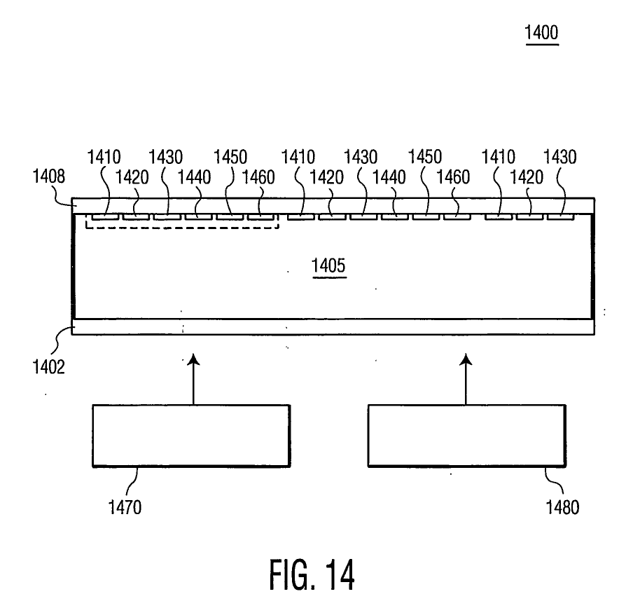

FIG. 14 illustrates a third embodiment of a color display device using six primary colors.

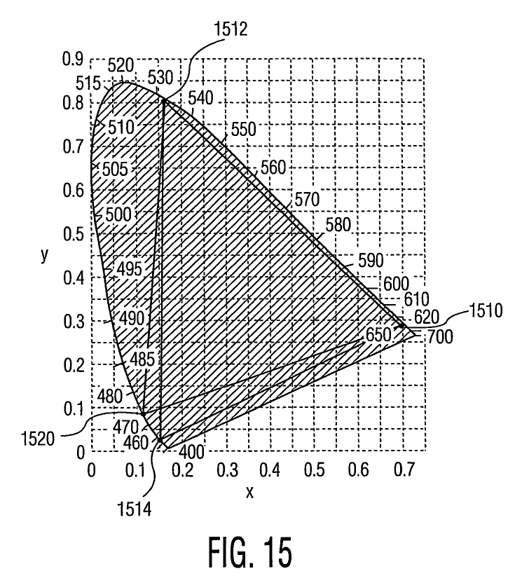

FIG. 15 illustrates an embodiment of the invention using four primary colors.

FIG. 11 shows the gamut of colors that can be reproduced with a color display system using two different sets of three primary colors on the 1931 CIE standard chromaticity diagram.

The first set of primary colors, labeled 1110, 1112, and 1114 (e.g., R1, G1, and B1), are located relatively close to the locus of the 1931 CIE standard chromaticity diagram. The first set of primary colors 1110, 1112, and 1114 can cover a large area within the color space, and are able to generate very saturated colors. The first set of primary colors 1110, 1112, and 1114 defines a first color gamut.

Meanwhile, the second set of primary colors, labeled 1120, 1122, and 1124 (e.g., R2, G2, and B2), are located inside the first color gamut. The second set of primary colors 1120, 1122, and 1124 defines a second color gamut. Beneficially, the second color gamut is located entirely within the first color gamut. In general, the second set of primary colors 1120, 1122, and 1124 are all less saturated than the first set of primary colors. However, in general, the second set of primary colors 1120, 1122, and 1124 can generate very high brightness levels compared to the first set of primary colors.

In practice, then, a color display system can use two sets of three primary color elements corresponding to the two sets of three primary colors.

In such a color display system, all colors that are located within the second color gamut of the second set of primary colors 1120, 1122, and 1124 can be obtained using the second set of color elements. Accordingly, high brightness levels can be achieved as desired. Optionally, colors that are located within the second color gamut can be obtained by mixing all six primary colors.

Meanwhile, all colors outside the second color gamut, but within the first color gamut of the first set of primary colors 1110, 1112, and 1114, can be produced using the first set of primary color elements.

These principles illustrated with respect to FIG. 11 can be used to produce color display systems capable of simultaneously meeting high color saturation and brightness requirements. Furthermore, because six color elements are used to span the reproduced range of colors, instead of the three colors used in existing color display systems, the saturation requirements and brightness requirements can be effectively separated. The first set of three primary colors can be relatively optimized for high color saturation, while the second set of three primary colors can be relatively optimized for high brightness levels. Therefore, there is no longer such a severe requirement to use only materials that can simultaneously provide high color saturation and brightness. Accordingly, a color display system with two sets of primary colors has more flexibility in choice of materials, and can utilize a wider range of materials.

FIG. 12 illustrates a first embodiment of a color display system using two sets of three primary color elements. FIG. 12 is a block diagram of a laser display system 1200. In the display system 1200, a first set of three primary color elements comprise lasers 1210, 1220, and 1230, and a second set of three primary color elements comprise lasers 1240, 1250 and 1260. Each of the six lasers 1210-1260 outputs light having a different color in response to signals from a video controller 1270. A color combiner 1280 combines the lights from the six lasers to display a desired image. Beneficially, the first set of lasers 1210, 1220 and 1230 are relatively low-lumen-output lasers and the second set of lasers 1240, 1250 and 1260 are high-lumen-output lasers capable of providing high brightness levels (e.g., R2, G2 and B2). Of course, in the case of a color display system using six lasers, all of the colors are saturated.

FIG. 13 illustrates a second embodiment of a color display device using six primary colors. The color display system 1300 is a color phosphor-based display system. The display system 1300 includes a plurality of color pixels, each of the pixels including a first set of three primary color elements comprising phosphors 1310, 1320, and 1330, and a second set of three primary color elements comprising phosphors 1340, 1350 and 1360. Each of the six phosphors 1310-1360 outputs light having a different color in response to one or more scanning signals. In one variation, the scanning beam is an infrared (IR) laser beam and the phosphors transform the IR light into the required colors. In a second variation, the color display system is a cathode ray tube (CRT) and the scanning beam is an electron beam. The scanning signal(s) is/are controlled by a video controller 1370. Beneficially, the first set of phosphors 1310, 1320 and 1330 are relatively low-brightness phosphors providing very saturated colors (e.g., R1, G1 and B1). Also beneficially, the second set of phosphors 1340, 1350 and 1360 are high-intensity phosphors outputting less saturated colors with high brightness levels (e.g., R2, G2 and B2).

FIG. 14 illustrates a third embodiment of a color display device using six primary colors. FIG. 14 shows a color liquid crystal display (LCD) system 1400, including first and second substrates 1402 and 1408 with a liquid crystal material 1405 disposed therebetween. The display system 1400 also includes a plurality of color pixels, each of the pixels including the first set of three primary color elements comprising color filters 1410, 1420, and 1430, and the second set of three primary color elements comprising color filters 1440, 1450 and 1460. The LCD system 1400 may be substantiated in a variety of forms, including passive matrix, active matrix, thin-film transistor (TFT) active matrix, transmissive mode, reflective mode, transflective mode, etc. The only requirement is that it uses color filters or their equivalent to display colored images. Beneficially, color filters may be disposed on one or both of the substrates 1402 and 1408. Furthermore, the color filters may be arranged in a variety of patterns, including stripes, “checkerboard,” etc. Each of the six color filters 1410-1460 passes light having a different color. Beneficially, the first set of color filters 1410, 1420 and 1430 have very saturated colors (e.g., R1, G1 and B1). Also beneficially, the second set of color filters 1440, 1450 and 1460 have less saturated colors, but provide high brightness levels (e.g., R2, G2 and B2). Typically, each color pixel has six “sub-pixels” corresponding to the six primary colors. One or more row drivers 1470 and column drivers 1480 control the “sub-pixels” and thereby the color pixels, to display a desired image.

Of course, other embodiments are possible using the principles described above, including electroluminescent devices (ELD), light emitting diode (LED) displays, LCD and liquid crystal on silicon (LCOS) projection displays, color plasma displays, raser base displays and poly-LED devices, etc.

FIG. 15 illustrates a color gamut spanned by an embodiment using only four primary color elements. In this example, a display system has primary color elements corresponding to first through fourth colors as shown in FIG. 15. The first through third primary colors, 1510, 1512, and 1514, span a first color gamut. Beneficially, the fourth primary color 1520 is produced with a primary color element capable of generating high brightness values—preferably significantly brighter than the brightness value(s) of the primary color elements for one, or all, of the first through third colors 1510-1514. The fourth color 1520 may be located outside the first color gamut, thereby expanding the total color gamut that can be reproduced by the display system. Also, the fourth color 1520 may have a same general hue as one of the first through third colors, e.g., third color 1514. For example, both the third and fourth color elements may produce a substantially blue color. In that case, the primary color element for the fourth color 1520 would be capable of generating a significantly higher brighter value (more lumens) than the color element for the third color 1514. Also, the combination of the first through fourth colors spans a second color gamut which includes colors not included in the first color gamut.

As before, a color display system operating with four colors according to these principles may comprise a CRT, an LCD, an ELD, a color plasma display, etc. A concrete example will now be provided in the context of a laser color projection display system.

A blue (B) channel for such a system might comprise two lasers: (1) a deep blue (453 nm) laser for producing the blue saturated colors, but outputting light with a low number of lumens; and (2) a high-lumen blue (473 nm) laser for producing the bright blue light contributions. Advantageously, it is easier to make a 473 nm laser with higher lumen levels and a sufficient life time, than to do so with a 453 nm laser.

Furthermore, such a system might use only a single laser for the green (G) channel, and only a single laser for the red (R) channel, e.g., a green (532 nm) laser for producing the green saturated colors and the bright green light contributions, and a red (630 nm) laser for producing the red saturated colors and the bright red light contributions. In that case, the green (G) laser and the red (R) laser each need to individually provide the combined color saturation, brightness and lifetime requirements.

Meanwhile, for the blue (B) channel, the 453 nm laser is used to generate the highly saturated blue colors of a desired color gamut (e.g., the EBU color gamut), while the 473 nm laser is used to generate high-lumen (bright) blue light fluxes when brighter images are displayed. That is, the 453 nm, 532 nm, and 630 nm lasers together can span a desired color gamut (e.g., the EBU color gamut), but together they cannot achieve a desired brightness level. Conversely, the 473 nm, 532 nm, and 630 nm lasers together can produce a high brightness level, but together they cannot span all of a desired color gamut (e.g., the EBU color gamut). For example, the 473 nm, 532 nm, and 630 nm lasers together are not capable of covering the lower left region of the EBU color gamut.

Thus, the combination of a 453 nm laser and a 473 nm laser to span the entire EBU standard color gamut, and to achieve high brightness levels, is a technically feasible solution to covering the entire desired color gamut and achieving desired brightness levels, at a lower cost. Similarly, two lasers could be used to generate the green (G) and/or the red (R) channels.

Variations of the example above are possible within the principles disclosed herein. For example, the first through third colors may span the entire desired color gamut, and the fourth color may lie inside the first color gamut, only being used to increase to increase brightness. Furthermore, another variation is possible where the first through third colors together cannot span a desired color gamut, and the fourth laser not only increases the brightness level, but also provides a missing range of color to span the desired color gamut.

While preferred embodiments are disclosed herein, many variations are possible which remain within the concept and scope of the invention. The invention therefore is not to be restricted except within the spirit and scope of the appended claims.

1. A color display system comprising:
a plurality of pixels, wherein each pixel comprises,
a first set of three primary color elements, each of said primary color elements of the first set having a different color than any of the other primary color elements of the first set, and
a second set of three primary color elements, each of said primary color elements of the second set having a different color than any of the other primary color elements of the second set and the first set; and
means for controlling the plurality of pixels to display an image.

2. The color display system of claim 1, wherein at least one of the primary color elements of the second set is capable of producing a substantially greater brightness level than at least one of the primary color elements of the first set.

3. The color display system of claim 1, wherein at least one of the primary color elements of the second set is capable of producing a substantially greater brightness level than any of the primary color elements of the first set.

4. The color display system of claim 1, wherein the six primary color elements comprise six phosphors, each one of said phosphors including at least one material not present in any of the other phosphors.

5. The color display system of claim 1, wherein the means controlling the plurality of pixels to display an image comprises a scanning electron beam.

6. The color display system of claim 1, wherein the six primary color elements comprise six color filters.

7. The color display system of claim 6, further comprising:
a first substrate;
a second substrate; and
a liquid crystal material between the first and second substrates,
wherein each of the six color filters of each pixel are disposed on the first or second substrate.

8. The color display system of claim 7, wherein the means for controlling the plurality of pixels to display an image comprises a row driver and a column driver.

9. The color display system of claim 1, wherein the colors of the first set of three primary color elements are each located closer to a locus of a 1931 CIE standard chromaticity diagram than the colors of the second set of three primary color elements.

10. A color display system, comprising:
first, second, and third primary color elements, the first through third primary color elements having three corresponding colors that are different from each other, wherein said first through third primary color elements together span a first color gamut; and
a fourth primary color element having a different color than any of the first through third primary color elements,
wherein the fourth primary color has a color point that is closer to a color point of at least one of the first through third primary color elements than to a color point of a white color for the system, and
wherein the fourth primary color element is capable of producing a substantially greater brightness level than a one of the first through third primary color elements having a color closest to the color of the fourth primary color element.

11. The color display system of claim 10, wherein the color of the fourth primary color element lies outside the first color gamut such that the display system can display images having colors spanning a second color gamut larger than the first color gamut by proportionately combining the colors of the first through fourth color elements.

12. The color display system of claim 10, wherein said first, second, and fourth primary color elements together span a second color gamut, wherein the second color gamut includes a first portion of a European Broadcast Union (EBU) standard color gamut and does not include a second portion of the EBU standard color gamut.

13. The color display system of claim 13, wherein the first color gamut includes the EBU standard color gamut.

14. A method of displaying a pixel of an image, comprising:
providing first, second, and third primary color elements, the first through third primary color elements having three corresponding colors that are different from each other, and said first through third primary color elements together spanning a first color gamut;
providing a fourth primary color element having a different color than any of the first through third primary color elements, wherein the fourth primary color has a color point that is closer to a color point of at least one of the first through third primary color elements than to a color point of a white color for the system, and is capable of producing a substantially greater brightness level than a one of the first through third primary color elements having a color closest to the color of the fourth primary color element; and
proportionately combining the colors produced the first through fourth color elements to produce a desired pixel color.

15. The method of claim 15, further comprising providing fifth and sixth primary color elements having a different color than any of the first through third primary color elements.

16. The method of claim 16, wherein the colors of the fourth through sixth color primary elements are each located closer to a locus of a 1931 CIE standard chromaticity diagram than the colors of the first through third primary color elements.

17. The method of claim 15, wherein the color of the fourth primary color element lies outside the first color gamut.

18. The method of claim 15, wherein providing the first through fourth primary color elements comprises providing four phosphors, each one of said phosphors including at least one material not present in any of the other phosphors.

19. The method of claim 14, wherein providing the first through fourth primary color elements comprises providing four lasers.
